(19) United States
(12) Patent Application Publication
(10) Pub. No.: US 2012/0204743 A1
(43) Pub. Date: Aug. 16, 2012

(54) Printer for a Gaming Machine

(76) Inventor: Po-Chang Yen, Tainan (TW)

(21) Appl. No.: 13/025,254

(22) Filed: Feb. 11, 2011

(51) Int. Cl. B41K 3/08

(52) U.S. Cl. 101/66

(57) ABSTRACT

A printer for a gaming machine includes a frame having a rear portion rotatably supporting a roll of paper. A panel is fixed to a front portion of the frame. An opening extends from an inner face through an outer face of panel. A guide is fixed in the opening and made of light-transmitting material. The guide includes an extension extending from a surface thereof A portion of the extension of the guide is located beyond the inner face of the panel. A lighting device is fixed to the panel and includes a lighting unit electrically connected to a main board fixed to the frame. The lighting unit is capable of emitting light beams to an upper face of the guide to lighten the guide. A printer prints out information of a result of playing the gaming machine on the paper.

### BACKGROUND OF THE INVENTION

The present invention relates to a printer and, more particularly, to a printer mounted in a gaming machine for printing out information of points or prizes got by players while providing lights of differing colors to indicate differing statuses of the printer.

Players can get points while playing gaming machines of certain types in playgrounds. The players can accumulate the points that can be exchanged for prizes. Conventional gaming machines include a lottery ticket machine that outputs a plurality of lottery tickets with points by a computer after the game is over, and the player can exchange the lottery tickets for prizes according to the total points of the lottery tickets. The lottery tickets are printed and perforated before they are rolled and placed in the lottery machine. However, it is inconvenient for the player to keep the lottery tickets before exchange for the prizes, and use of the lottery tickets is not eco-friendly.

A built-in lottery ticket machine has been proposed and can directly print out the points on a single piece of paper obtained by the player. The player can exchange the piece of paper for the prizes corresponding to the points on the paper. However, a manager of the playground can not judge whether the lottery ticket machine malfunctions by the operating panel of the lottery ticket machine. Namely, the manager has to regularly perambulate and open each gaming machine for inspection, which is time-consuming.

### BRIEF SUMMARY OF THE INVENTION

A printer for a gaming machine according to the present invention includes a frame having front and rear portions spaced along a first axis and an intermediate portion between the front and rear portions. A main board is fixed to the frame. The rear portion rotatably supports a shaft around which a roll of paper is mounted. A printing device is fixed to the intermediate portion. The paper is extended through the printing device. The printing device is adapted to print out information containing a result of playing the gaming machine. A panel is fixed to the front portion of the frame. The panel includes inner and outer faces spaced along the first axis. An opening extends from the inner face through the outer face. A guide is fixed to the panel and made of light-transmitting material. The guide includes a surface and an extension extending from the surface along the first axis. The extension includes upper and lower faces spaced along a second axis perpendicular to the first axis. The guide is fixed in the opening of the panel. A portion of the extension of the guide is located beyond the inner face of the panel. A lighting device is fixed to the panel. The lighting device includes a lighting unit electrically connected to the main board. The lighting unit is capable of emitting light beams to the upper face of the guide to lighten the guide.

Preferably, the panel includes a notch formed in the inner face and in communication with the opening. The lighting unit is received in the notch. The light beams emitted by the lighting unit are reflected by the notch to the guide.

Preferably, a connecting member is fixed to the panel and includes two fixing portions spaced along a third axis perpendicular to the first and second axes. A groove is defined between the two fixing portions. The lighting unit is received in the groove.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows an exploded, perspective view of a printer according to the present invention.

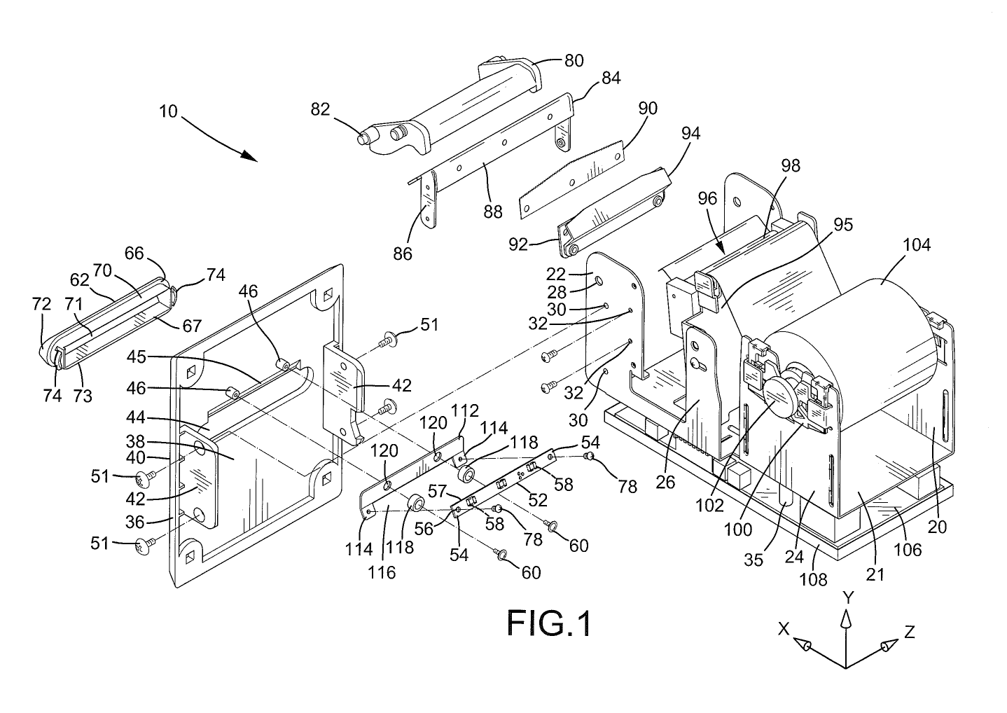

FIG. 2 shows a perspective view of the printer of FIG. 1.

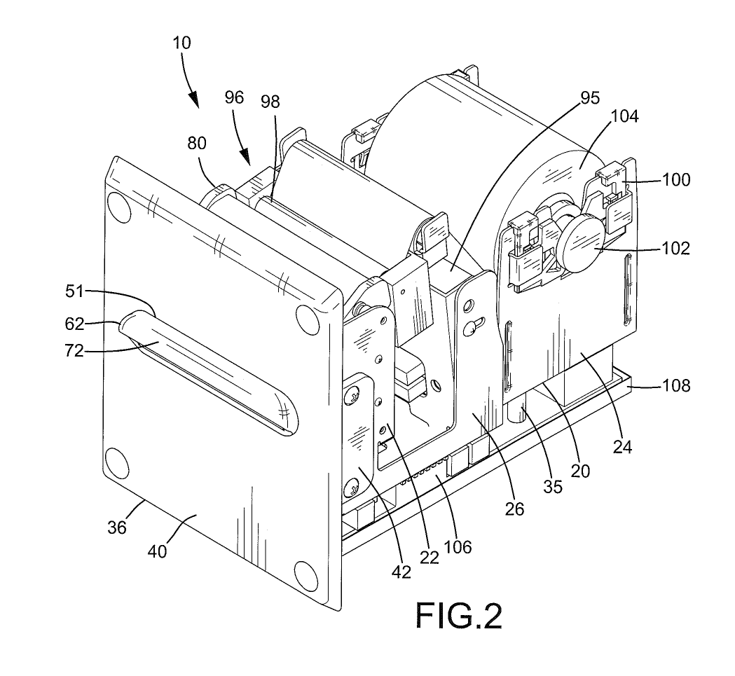

FIG. 3 shows a perspective view of a gaming machine equipped with the printer of FIG. 1.

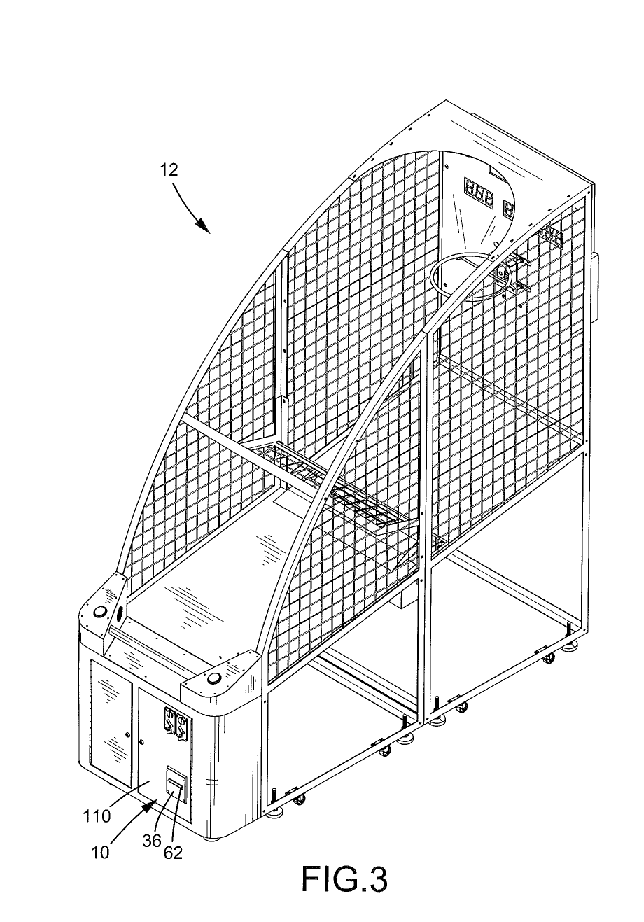

FIG. 4 shows a side elevational view of the printer of FIG. 1, with portions cross sectioned.

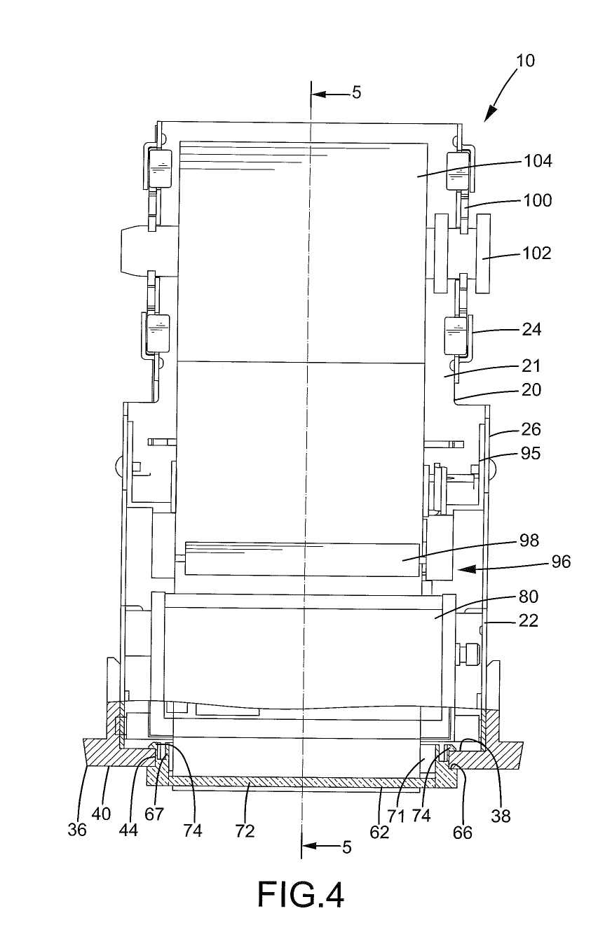

FIG. 5 shows a cross sectional view according to section line 5-5 of FIG. 4.

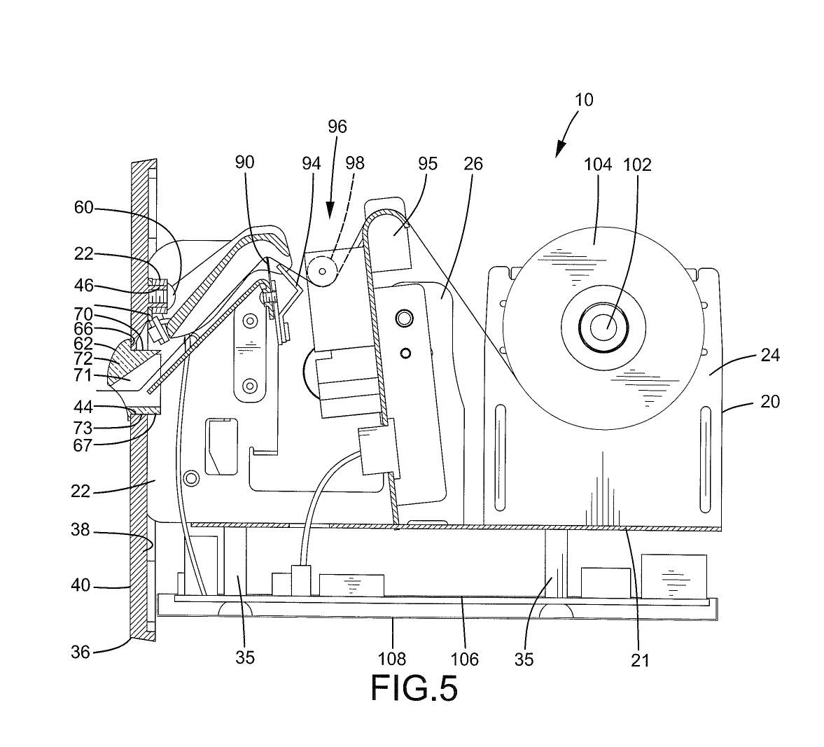

FIG. 6 shows an enlarged view of a portion of FIG. 5.

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “lower”, “upper”, “inner”, “outer”, “side”, “end”, “portion”, “lateral”, and similar terms are used herein, it should be understood that these terms have reference only to the structure shown in the drawings as it would appear to a person viewing the drawings and are utilized only to facilitate describing the invention.

### DETAILED DESCRIPTION OF THE INVENTION

A printer is shown in the drawings and generally designated 10. Printer 10 is mounted in an operating panel 110 of a gaming machine 12. When a player gets points by playing gaming machine 12, printer 10 prints out a piece of paper indicating the points obtained by the player, so that the player can take the piece of paper to a manager of the gaming machine 12 to exchange for prizes corresponding to the points.

According to the form shown, printer 10 includes a first frame 20 having a bottom board 21. First frame 20 further includes front and rear portions 22 and 24 spaced along a first axis X and an intermediate portion 26 between front and rear portions 22 and 24. Each of front, intermediate, and rear portions 22, 26, and 24 includes two lateral walls extending perpendicularly from bottom board 21 along a second axis Y perpendicular to first axis X. The two lateral walls of Front portion 22 include a pair of aligned pivot holes 28, two pairs of aligned first fixing holes 30, and two pairs of aligned second fixing holes 32. First frame 20 further includes a plurality of pegs 35 provided on a bottom side of bottom board 21.

According to the form shown, printer 10 further includes a panel 36 fixed on first frame 20. Panel 36 includes inner and outer faces 38 and 40 spaced along first axis X. Two wings 42 extend away from inner face 38 of panel 36 along first axis X and are spaced from each other along a third axis Z perpendicular to first and second axes X and Y. Panel 36 further includes two engagement portions 46 in the form of pegs formed on inner face 38 and spaced along second axis Y. An opening 44 extends from inner face 38 through outer face 40 along first axis X. A notch 45 is formed in inner face 38 and in communication with opening 44. Engagement portions 46 are located above and spaced from notch 45 along second axis Y. Wings 42 abut outer sides of the two lateral walls of front portion 22 of first frame 20. Fasteners 51 are extended through wings 42 into first fixing holes 30 of first frame 20 and through fixing panel 36 to first frame 20.

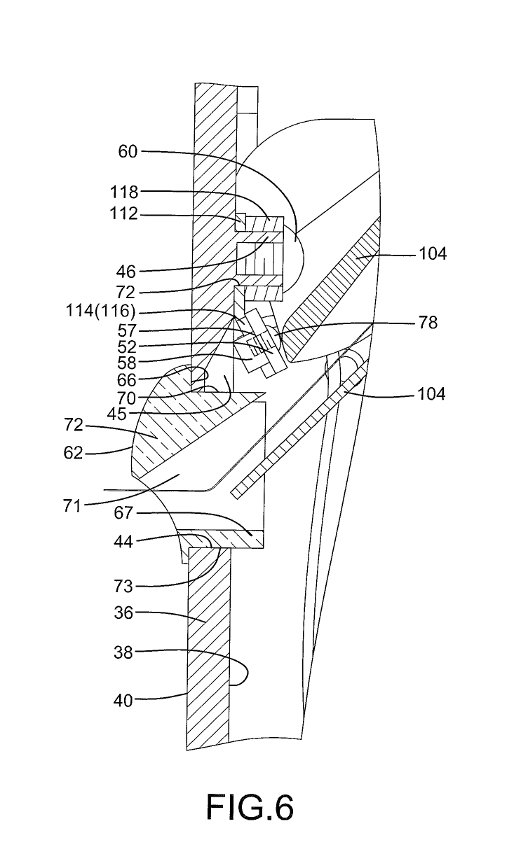

According to the form shown, printer 10 further includes a lighting device 52 and a connecting member 112. Lighting device 52 includes two ends 54 spaced along third axis Z and each having a through-hole 56. A lighting unit 58 is fixed to a lower side 57 of lighting device 52 and includes a plurality of lighting elements such as light-emitting diodes. The connecting member 112 includes two fixing portions 114 spaced along third axis Z. A groove 116 is formed between fixing portions 114. Connecting member 112 further includes two through-holes 120 spaced along third axis Z. Connecting member 112 is mounted to inner face 38 of panel 36. Engagement portions 46 of panel 36 extend through through-holes 120 of connecting member 112, and groove 116 is aligned with notch 45 (FIG. 6). Two screws 60 are extended through two abutment members 118 mounted around engagement portions 46 and each have a head abutting one of abutment members 118, fixing connecting member 112 to panel 36. Lighting device 52 is fixed to fixing portions 114 of connecting member 112 by two screws 78 (FIG. 6). Lighting unit 58 is received in groove 116 and notch 45.

According to the form shown, printer 10 further includes a guide 62 mounted on panel 36 and made of light-transmittable material, such as acrylic. Guide 62 includes a protruded portion 72 and a surface 66 spaced from protruded portion 72 along first axis X. An extension 67 extends away from surface 66 along first axis X. Extension 67 includes upper and lower faces 70 and 73 spaced along second axis Y. Guide 62 further includes an outlet 71 extending from an end face of extension 67 through protruded portion 72 along first axis X. Guide 62 further includes two hooked portions 74 extending from surface 66 along first axis X. Extension 67 are located intermediate and spaced from hooked portions 74.

Guide 62 is inserted into opening 44 of panel 36 from outside. A portion of extension 67 is located beyond inner face 38 of panel 36. Hooked portions 74 are retained to inner face 38 of panel 36. Extension 67 of guide 62 is in tight coupling with an inner periphery of opening 44. Protruded portion 72 of guide 62 is located beyond outer face 40 of panel 36. Thus, guide 62 is fixed to panel 36. Upper face 70 of guide 62 faces and is aligned with notch 45 of panel 36. Lighting unit 58 is received in a space defined between upper face 70 of guide 62, notch 45 of panel 36, and lighting device 52. Thus, the light beams emitted by lighting unit 58 can be reliably projected to guide 62.

According to the form shown, printer 10 further includes a cover 80 having two pins 82 pivotably received in pivot holes 28 of front portion 22 of first frame 20. Cover 80 is located in front portion 22 of first frame 20. A front end of cover 80 is spaced from inner face 38 of panel 36 along first axis X, such that cover 80 will not be a block between lighting unit 58 of lighting device 52 and upper face 70 of guide 62.

According to the form shown, printer 10 further includes a guiding member 84, a cutter 90, a spacer 92, and an abutment plate 94. Guiding member 84 includes two arms 86 spaced along third axis Z and a mounting plate 88 interconnected between arms 86. Guiding member 84 is mounted in front portion 22 of first frame 20 by extending screws through second fixing holes 32 into holes of arms 86. Cutter 90 includes an upper face having plurality of teeth. Cutter 90 is fixed to mounting plate 88 of guiding member 84. Spacer 92 is fixed to cutter 90, and abutment plate 94 is fixed to spacer 92. Guiding member 84, cutter 90, spacer 92, and abutment plate 94 are spaced from cover 80 along second axis Y. A passageway 83 is defined between cover 80 and guiding member 84.

According to the form shown, printer 10 further includes a second frame 95 and a printing device 96 mounted to second frame 95. Printing device 96 includes a roller 98 rotatably mounted to an upper end thereof. Second frame 95 is fixed to intermediate portion 26 of first frame 20. Roller 98 is at a level approximately the same as the upper face of cutter 90. Roller 98 is spaced from abutment plate 94 by a gap along first axis X.

According to the preferred form shown, printer 10 further includes two attachment members 100, a shaft 102, and a roll of paper 104. Attachment members 100 are fixed to rear portion 24 of first frame 20. Shaft 102 is rotatably mounted between attachment members 100. The roll of paper 104 is mounted around shaft 102. A distal end of paper 104 is wound around a top end of second frame 95 and enters printing device 96. Then, the distal end of paper 104 is wound around roller 98 of printing device 96 and then exits printing device 96 and passes through passageway 83 to outlet 71 of guide 62.

According to the form shown, printer 10 further includes a main board 106 and a chassis 108. Main board 106 is fixed to pegs 35 of first frame 20. Chassis 108 receives main board 106. Chassis 108 and main board 106 can be fixed by screws to pegs 35. Main board 106, lighting unit 58, and printing device 96 are electrically connected. Main board 106 controls on/off of lighting unit 58 and controls printing device 96 to print information on paper 104.

When printing device 96 prints out information, roller 98 of printing device 96 rotates on site to draw out paper 104. The distal end of paper 104 is outputted via outlet 71 of guide 62. The player can tear off the distal portion of paper 104 with cutter 90 cutting the distal portion from the remaining portion of paper 104. Thus, player can get a ticket (the cut distal portion of paper) including information of the result (such as the points he got) after playing gaming machine 12.

The light beams emitted by lighting unit 58 of printer 10 is projected to upper face 70 of guide 62 and transmits guide 62, creating uniform light on guide 62 and lightening guide 62 including exposed protruded portion 72. Note that a portion of the light beams emitted by the lighting unit 58 can be reflected by notch 45 to guide 62. Furthermore, lighting unit 58 can emit light beams of different colors that can be mixed to provide various, colorful lighting effects on panel 36 of printer 10. Further, the player or a manager of gaming machine 12 can identify the status of printer 10 by the color of light on guide 62. As an example, green indicates printer 10 is in a standby status, flickering green indicates printer 10 is printing, orange indicates paper 104 has run out, and flickering red indicates malfunction of printer 10. In addition to providing aesthetic lighting effects, the status of printer 10 can be exactly indicated. Thus, printer 10 can be repaired whenever malfunctions, reducing the costs and time for maintaining printer 10.

Now that the basic teachings of the present invention have been explained, many extensions and variations will be obvious to one having ordinary skill in the art. For example, guide 62 can be engaged with panel 36 by other provisions instead of using hooked portions 74. As an example, guide 62 can be bonded or screwed to panel 36. Furthermore, panel 36 can be fixed to front portion 22 of first frame 20 by other provisions instead of using wings 42. As an example, panel 36 can include a plurality of hooks formed on inner face 38 and extending along first axis X, and front portion 22 of first frame 20 includes holes for engaging the hooks. Further, guide 62 does not have to include protruded portion 72. In this case, guide 62 is still exposed outside of outer face 40 of panel 36, and the lighting effects on guide 62 can still be observed via panel 36. Further, through-holes 56 can be formed in the intermediate portion of lighting unit 58. Engagement portions 46 of panel 36 can be provided at an intermediate portion of inner face 38 of panel 36 along third axis X. Further, printer 10 does not have to include connecting member 112 and notch 45. Engagement portions 46 can be inclined surfaces, and lighting device 52 can be directly screwed to engagement portions 46, such that lighting unit 58 face upper face 70 of guide 62.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A printer for a gaming machine comprising, in combination:
a frame (20) including front and rear portions (22, 24) spaced along a first axis (X) and an intermediate portion (26) between the front and rear portions (22, 24), with a main board (106) fixed to the frame (20), with the rear portion (24) rotatably supporting a shaft (102) around which a roll of paper (104) is mounted, with a printing device (96) fixed to the intermediate portion (26), with the paper (104) extended through the printing device (96), with the printing device (96) adapted to print out information containing a result of playing the gaming machine (12);
a panel (36) fixed to the front portion (22) of the frame (20), with the panel (36) including inner and outer faces (38, 40) spaced along the first axis (X), with an opening (44) extending from the inner face (38) through the outer face (40);
a guide (62) fixed to the panel (36) and made of light-transmitting material, with the guide (62) including a surface (66) and an extension (67) extending from the surface (66) along the first axis (X), with the extension (67) including upper and lower faces (70, 73) spaced along a second axis (Y) perpendicular to the first axis (X), with the guide (62) fixed in the opening (44) of the panel (36), with a portion of the extension (67) of the guide (62) located beyond the inner face (38) of the panel (36); and
a lighting device (52) fixed to the panel (36), with the lighting device (52) including a lighting unit (58) electrically connected to the main board (106), with the lighting unit (58) capable of emitting light beams to the upper face (70) of the guide (62) to lighten the guide (62).

2. The printer for a gaming machine as claimed in claim 1, with the panel (36) including a notch (45) formed in the inner face (38) and in communication with the opening (44), with the lighting unit (58) received in the notch (45), with the light beams emitted by the lighting unit (58) being reflected by the notch (45) to the guide (62).

3. The printer for a gaming machine as claimed in claim 1, further comprising, in combination: a connecting member (112) fixed to the panel (36) and including two fixing portions (114) spaced along a third axis (Z) perpendicular to the first and second axes (X, Y), with a groove (116) defined between the two fixing portions (114), with the lighting unit (58) received in the groove (116).
